(19) United States
(12) Patent Application Publication
(10) Pub. No.: US 2016/0196430 A1
(43) Pub. Date: Jul. 7, 2016

(54) Protection Method and Computer System Thereof

(71) Applicant: WISTRON CORPORATION, NEW TAIPEI CITY (TW)

(72) Inventor: Chih-Ming Chen, New Taipei City (TW)

(21) Appl. No.: 14/799,587

(22) Filed: Jul. 15, 2015

(30) Foreign Application Priority Data
Jan. 6, 2015 (TW) 104100328

(51) Int. Cl. G06F 21/56; G06N 99/00; G06F 17/30

(52) U.S. Cl. CPC G06F 21/56; G06F 17/30914; G06F 17/30598; G06N 99/005

(57) ABSTRACT

A protection method to be utilized for a user equipment against an attack of a malware includes obtaining an observed information including at least one of a sampled information and a labeled information; transforming the observed information to a first mapping information according to a transductive machine learning; transforming the first mapping information to a second mapping information according to an inductive machine learning, and transmitting the second mapping information to a machine leaning module; and the machine leaning module receiving an input information, and utilizing a pattern database to generate a pattern recognition result, so as to provide the user equipment with a protection operation.

### BACKGROUND OF THE INVENTION

1. Field of the Invention

The present invention relates to a protection method and a computer system thereof, and more particularly, to a protection method and a computer system thereof to protect a user equipment against a malware.

2. Description of the Prior Art

During the network service rapidly developing, people are used to highly rely on the network information, which results in the entrance of a variety of malware, e.g. virus, spyware, adware or spam, through the related network services to hack or attack people's computer systems or mobile devices. Accordingly, software/hardware of the computer systems or mobile devices could be damaged, or some electronic files might be stolen.

To strengthen the protection of the computer system or the mobile device, the antivirus software may be installed inside the computer system or the mobile device for recognizing or isolating the potential malware. Conventionally, the virus pattern database of the antivirus software is updated or maintained by manual operations, to gradually compare recognized potential virus patterns with the virus pattern database, so as to reasonably simulate the potential virus patterns and to provide the accurately protection methods/scripts for the computer system or the mobile device. For the rapid and unpredictable changes of programming codes of the malware, the antivirus software of the computer system and the mobile device should be timely updated in order to download the latest virus patterns. However, the volume of the virus patterns in the database might be too many, and the speed of the manual updating for the database might be slower than the speed of the changes of the programming code of the malware, which results in more threats for the computer system and the mobile device exposing to such varieties of malware.

Therefore, it has become an important issue to provide a protection method and a computer system thereof for protecting the user equipment against the malware.

### SUMMARY OF THE INVENTION

Therefore, the primary objective of the present invention is to provide a protection method and a computer system thereof for protecting the user equipment against the malware.

The present invention discloses a protection method to be utilized for a user equipment against an attack of a malware. The protection method comprises obtaining an observed information comprising at least one of a sampled information and a labeled information; transforming the observed information to a first mapping information according to a transductive machine learning; transforming the first mapping information to a second mapping information according to an inductive machine learning, and transmitting the second mapping information to a machine leaning module; and the machine leaning module receiving an input information, and utilizing a pattern database to generate a pattern recognition result; and transmitting the pattern recognition result to the user equipment for a protection operation.

The present invention further discloses a computer system coupled to a user equipment against an attack of a malware. The computer system comprises a processing unit; and a storage device, coupled to the processing unit and storing a program code for processing a protection method. The protection method comprises obtaining an observed information comprising at least one of a sampled information and a labeled information; transforming the observed information to a first mapping information according to a transductive machine learning; transforming the first mapping information to a second mapping information according to an inductive machine learning, and transmitting the second mapping information to a machine leaning module; and the machine leaning module receiving an input information, and utilizing a pattern database to generate a pattern recognition result; and transmitting the pattern recognition result to the user equipment for a protection operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a computer system coupled to a user equipment according to an embodiment of the invention.

FIG. 2 illustrates a flowchart diagram of a protection process according to an embodiment of the invention.

FIG. 3 illustrates a schematic diagram of a pattern free diagram according to an embodiment of the invention.

FIG. 4 illustrates a flowchart diagram of a recognition process according to an embodiment of the invention.

FIG. 5 illustrates a schematic diagram of a mapping result of the transductive machine learning and the inductive machine learning according to an embodiment of the invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in sub-module. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

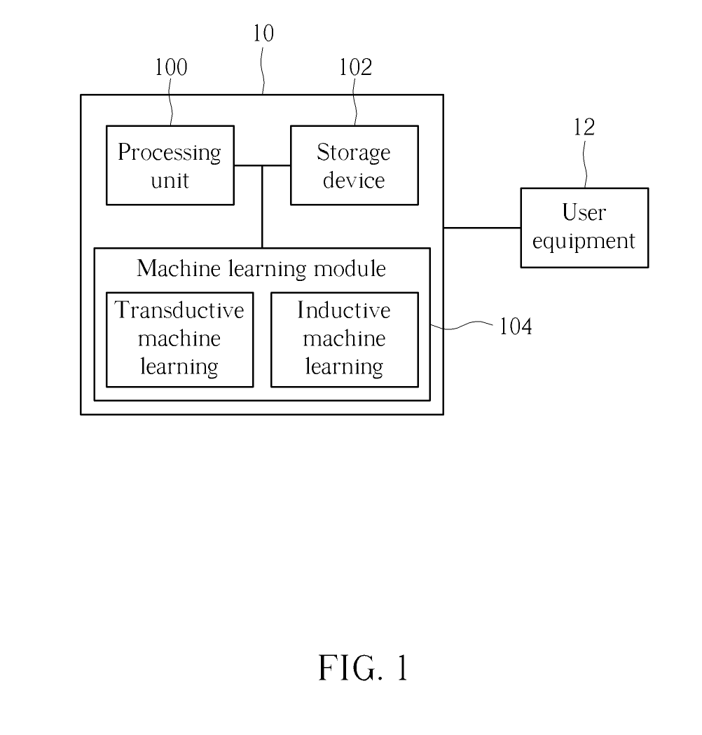

Please refer to FIG. 1, which illustrates a schematic diagram of a computer system 10 coupled to a user equipment 12 according to an embodiment of the invention. The computer system 10 of the embodiment has a basic structure comprising a main board, a processing unit, a memory, a hard disk, a south-bridge module, a north-bridge module, and etc., and should be well known to those skilled in the art. For the brevity, FIG. 1 of the invention only illustrates a processing unit 100, a storage device 102 and a machine learning module 104 of the computer system 10. The storage device 102 can be, but not limited to, read-only memory (ROM), random-access memory (RAM), flash, floppy disk, hardware disk, compact disc, USB flash drive, tape, database accessed via the Internet, or other types of storage medium known to those skilled in the art, to store a program code, such that the processing unit 100 can be utilized to process the program code to operate a protection method for the user equipment 12. The machine learning module 104 is coupled to the processing unit 100 and the storage device 102, and cooperates with the protection method to generate a pattern recognition result of virus, so as to prevent the user equipment 12 from attacking or invading of a malware, e.g. virus, spyware, adware or spam. Certainly, the embodiment of the invention directly and physically depicts the machine learning module 104 to demonstrate the main concept of the invention. In other embodiments, the processing unit 100 and the storage device 102 may functionally operate together to take place the machine learning module 104, so as to provide the operational mechanisms/functions of the machine learning module 104, which is also in the scope of the invention. Further, the embodiment of the invention stores program codes corresponding to a tranductive machine learning and a inductive machine learning in the storage device 102, and the program codes can also be operated by the processing unit 100 to process another training/learning operation. Also, the program codes of the tranductive machine learning and the inductive machine learning can independently form the other machine learning module(s) (not shown in FIG. 1) to be coupled to the processing unit 100 and the storage device 102, which is also in the scope of the invention.

In the embodiment of the invention, a transmission between the computer system 10 and the user equipment 12 can be a wireless transmission or a wired transmission, which is not limiting the scope of the invention. The user equipment 12 of the invention can be realized as another computer system, a mobile device (e.g. a mobile phone, a tablet or a PDA), a notebook, a smartwatch, a computing mobile device or an electronic media device, which is not limiting the scope of the invention. Certainly, the user equipment 12 of the invention can also be functionally integrated into the computer system 10 to form the single computer system, which is also in the scope of the invention.

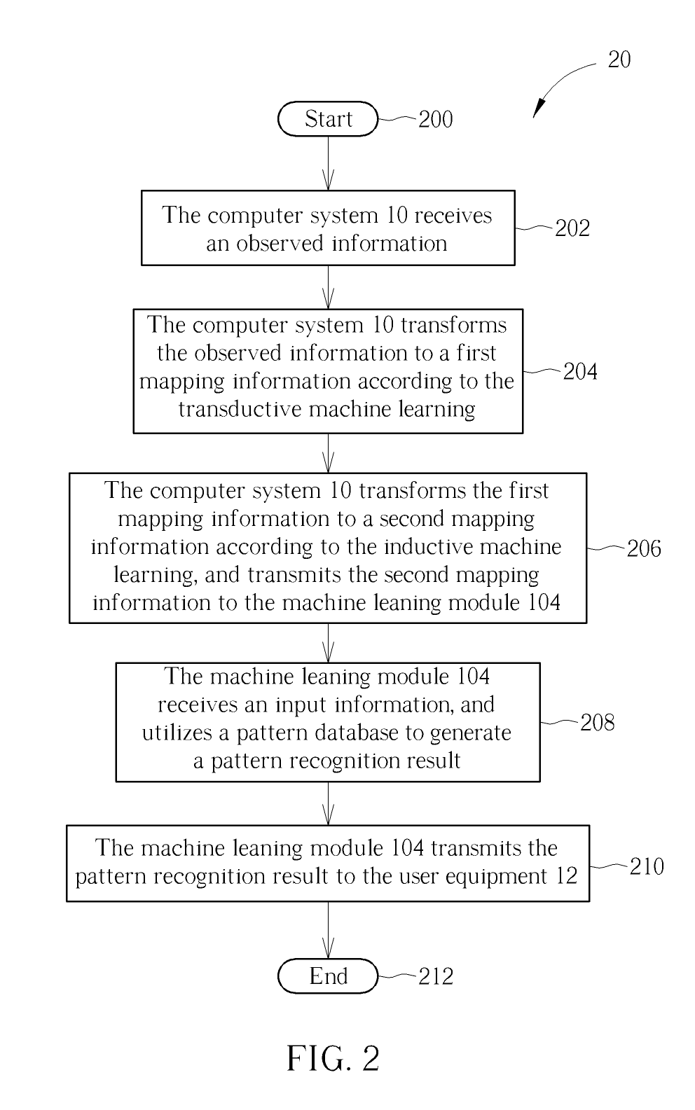

Further, the protection method for the user equipment 12 of the invention can be summarized as a protection process 20 to be stored as the program code in the storage device 102. The protection process 20, as shown in FIG. 2, of the invention comprises the following steps:

Step 200: Start.

Step 202: The computer system 10 receives an observed information.

Step 204: The computer system 10 transforms the observed information to a first mapping information according to the transductive machine learning.

Step 206: The computer system 10 transforms the first mapping information to a second mapping information according to the inductive machine learning, and transmits the second mapping information to the machine leaning module 104.

Step 208: The machine leaning module 104 receives an input information, and utilizes a pattern database to generate a pattern recognition result.

Step 210: The machine leaning module 104 transmits the pattern recognition result to the user equipment 12.

Step 212: End.

In step 202, the computer system 10 of the embodiment receives an operation or a data from a computing device, a remote storage device, an application program or a network information, e.g. an electronic file to be transmitted/carried, operations for installing a specific application, or serving the Internet through a webpage. The observed information of the embodiment is one of the operation or the data, which contributes to the finding of the potential/latest virus pattern information. Preferably, the observed information of the embodiment comprises at least one of a sampled information and a labeled information, wherein the labeled information is the information carrying at least one piece of the potential virus pattern information to be recognized, and the sampled information is the information carrying at least one piece of the potential virus pattern information not to be recognized so far.

In step 204, the computer system 10 processes the operation of the transductive machine learning to transform the observed information to the first mapping information. Preferably, if the observed information comprises the piece of the potential virus pattern information, the transductive machine learning can determines which types of the malware may exist after the computer system 10 receives the sampled/labeled information, to preliminarily classify the observed information and generate the first mapping information.

For example, the embodiment of the invention comprises four types of the malware as V_1-V_4, and each malware comprises a recognizable labeled information to be a virus V_1, a spyware V_2, a adware V_3 or a spam V_4. Under such circumstances, the transductive machine learning of the embodiment initially refers to the recognizable labeled information of each of the observed information Ob_1-Ob_N, to classify the observed information Ob_1-Ob_N into different group information G_1-G_4, wherein each group information is regarded as a labeled cluster to comprise the same recognizable labeled information. In the embodiment of the invention, the group information G_1-G_4 may individually represent the virus V_1, the spyware V_2, the adware V_3 and the spam V_4, but is not limiting the scope of the invention. Accordingly, a mapping result of the observed information Ob_1-Ob_N mapping to the group information G_1-G_4 is obtained to be the first mapping information, i.e. the transductive machine learning of the invention can preliminarily determine the classification of the malware for the observed information (comprising the sampled/labeled information) and generate the mapping result to be transmitted to the inductive machine learning as the input.

In step 206, the computer system 10 processes the operation of the inductive machine learning to transform the first mapping information to the second mapping information, so as to transmit the second mapping information to the machine leaning module 104. Preferably, the inductive machine learning classifies the labeled clusters into a plurality of sub-labeled clusters, to make the initially mapped observed information (comprising at least one of the sampled/labeled information) map to the plurality of sub-labeled clusters, so as to generate the second mapping information.

For example, the inductive machine learning of the embodiment can specifically classify each group information (e.g. the group information G_1) into a plurality of specific virus classification (e.g. V_1_1-V_1_n) according to different types, versions or codes of the specific virus classification, to obtain the mapping result of each group information (comprising at least one labeled/sampled information) mapping to the plurality of specific virus classification and form the second mapping result, so as to transmit the second mapping result to the machine learning module 104. Accordingly, the inductive machine learning of the embodiment can specifically classify the observed information (comprising at least one sampled/labeled information) belonging to different types of the malware into the plurality of specific virus classification with individual types, versions or codes of the specific virus classification, to render the mapping result for the machine learning module 104 and its related updating operations.

Preferably, the machine learning module 104 of the computer system 10 of the embodiment further comprises a pattern database storing a plurality of pattern information, and each pattern information is the labeled information which has been successfully mapped to one sub-labeled cluster before the protection method is processed and can help recognize the pieces of the potential virus pattern information. Accordingly, the machine learning module 104 of the embodiment utilizes the observed information (comprising at least one sampled/labeled information) and cooperates with two stage operations of the transductive machine learning and the inductive machine learning, to finish the efficient and precise learning/training operation of each observed information, so as to transmit the pieces of the potential virus pattern information and the corresponding mapping result of the specific type of the malware (i.e. the second mapping information) to the machine learning module 104, such that the pattern database of the machine learning module 104 can be dynamically and timely updated. In comparison with the prior art, the embodiment of the invention can utilize the training/learning operation of the transductive machine learning and the inductive machine learning to spare the manual operations of updating/disposing the large volume of virus pattern information in the pattern database, so as to improve the recognition efficiency for all types of the malware.

In other words, the machine learning module 104 of the embodiment can timely process the updating operation of the pattern database and simultaneously store the mapping result (i.e. the second mapping information). Accordingly, in step 208, when the machine learning module 104 receives the input information, the machine learning module 104 can process a recognition operation between the plurality of pattern information in the pattern database and the input information, to generate the pattern recognition result to the user equipment 12, so as to provide the user equipment 12 for the protection operation against different types of the malware. Preferably, the input information of the embodiment is obtained from the operation or the data of the computing device, the remote storage device, the application program, or the network information, to represent all types of the potential malware. The recognition operation of the embodiment can be realized as a separation operation, e.g. utilizing a joint feature function, to process a comparison between the input information and the pattern information in the pattern database, so as to determine/detect whether the potential malware is carried or transmitted inside the input information.

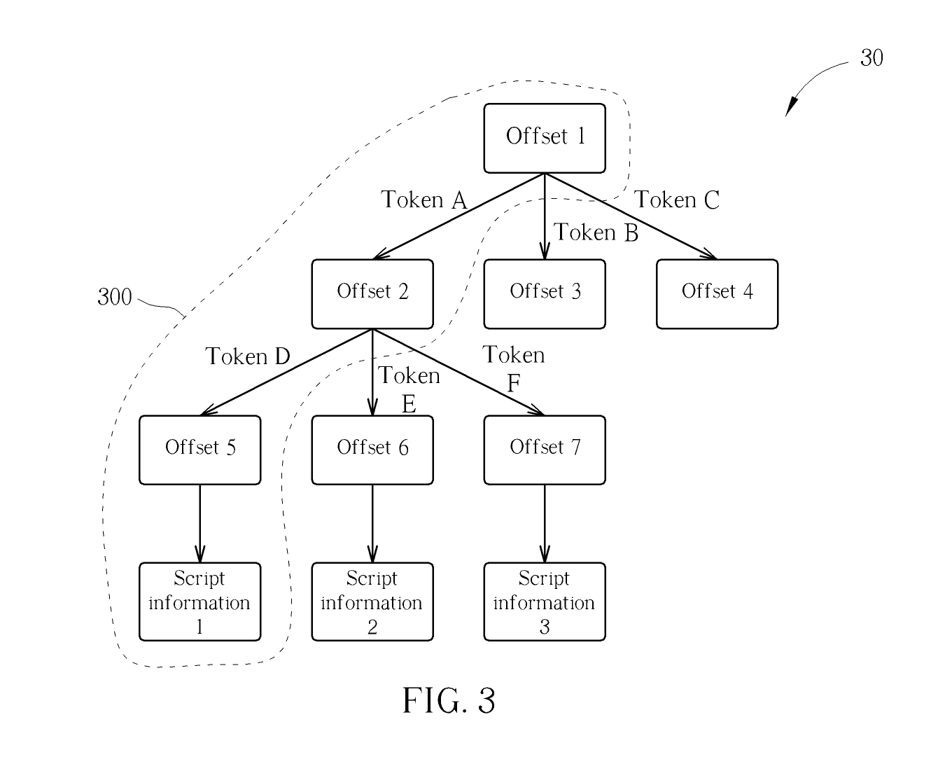

Noticeably, in order not to be easily detected by the antivirus software, the designer of the malware usually decomposes the body of the malware as a plurality of sub-bodies to be inserted inside some bit positions of one or many electronic file (s). In the embodiment, the pattern database of the invention utilizes one or many pattern tree diagram (s) to recognize the body or the sub-bodies of the malware. Please refer to FIG. 3, which illustrates a schematic diagram of a pattern free diagram 30 according to an embodiment of the invention. As shown in FIG. 3, the pattern free diagram 30 of the embodiment comprises a plurality of recognizable labeled information, e.g. a branch 300 circled in FIG. 3, and the branch 300 represents a structure pattern of one electronic file and positions of the plurality of sub-bodies of the malware are marked onto the branch 300. Specifically, each branch comprises a plurality of tokens to represent a single sub-body, and every two sub-bodies are serially connected via a line, which shows an offset information between the two tokens inside the electronic file. Also, a script information is coupled to an end of each recognizable labeled information. Once the body and/or the sub-bodies of the malware is detected, the script information is utilized to process a virus scanning operation, so as to delete or isolate the recognizable labeled information and to prevent the user equipment 12 from the attack of the malware.

In detail, during the recognition operation, the embodiment of the invention processes a semi-supervised structured learning operation and defines the joint feature function Φ(x, y), wherein x is a trained information and y is a candidate prediction value, and the joint feature function Φ(x, y) maps both x and y to a vector, which comprises a length n with different values according to different training modules. Also, the embodiment of the invention defines another function GEN to generate the candidate prediction value, the length n corresponds to a weighting vector w, and a number of a recursion operation is predetermined as well. Accordingly, the embodiment processes the recursion operation for ŷ=argmax{yεGEN(X)}(W^{T}Φ)(x, y)), and the weighting vector w is timely updated, i.e. processing an operation as w=w+c(−Φ(x, ŷ)+Φ(x, t)), wherein c is a learning constant. After the recursion operation has completed, the embodiment of the invention obtains the candidate prediction value to determine whether both the plurality of pattern information of the pattern database and the input information have the same at least one recognizable labeled information.

In the embodiment, after the semi-supervised structured learning operation has finished and the machine learning module 104 determines that the same at least one recognizable labeled information exists between the plurality of pattern information of the pattern database and the input information (i.e. the input information carries the potential virus pattern information), the machine learning module 104 of the embodiment can utilize the at least one recognizable labeled information and its coupled scrip information to be the pattern recognition result, to transmit the pattern recognition result to the user equipment 12 for the protection operation. Preferably, the computer system 10 of the embodiment can be a remote server to transmit the pattern recognition result (comprising the at least one recognizable labeled information and its coupled scrip information) to the user equipment 12 via a wireless transmission or a wired transmission, so as to process the virus scanning operation in the user equipment 12 for isolating or deleting the body/sub-bodies of the malware and to prevent the user equipment from the attack of the malware.

In another embodiment, if the at least one recognizable labeled information does not exist between the plurality of pattern information in the pattern database and the input information, the embodiment further processes a similarity kernels operation to generate a prescriptive analytics result or a cognitive analytics result as the pattern recognition result, so as to transmit the pattern recognition result to the user equipment 12 for the protection operation.

For example, in the similarity kernels operation, the embodiment defines a scoring function as F:X×Y [symbol] [symbol] , wherein x is an input information and y is the mapping result stored in the pattern database. Accordingly, the operation as ŷᵢ=argmax_{yεY}(Δ(yᵢ, y)+w^{T}Ψ(xᵢ, y)) or the operation of Mercer kernel as K((xᵢ, yᵢ),(xⱼ, yⱼ))= [symbol] |Ψ(xᵢ, yᵢ), Ψ(xⱼ, yⱼ)| [symbol] can be processed to obtain the scoring function as

$$F ( x , y ) = {w}^{* T} Ψ ( x , y ) = {\sum }_{\overline{y} ∈ W} α \frac{*}{y} ( \frac{1}{n} {\sum }_{i = 1}^{n} [ K ( ( x , y ) , ( {x}_{i} , {y}_{i} ) ) - K ( ( x , y ) , ( {x}_{i} , \overline{{y}_{i}} ) ) ] ) ,$$

and the operation as ŷᵢ=arg max_{yεY}(Δ(yᵢ, y)+F(x, y)) can also be processed to represent the potential malware combination as y̅=(y̅₁, . . . , ŷₙ). Besides, the embodiment of the invention processes the operation as K((xᵢ, yᵢ), (xⱼ, yⱼ))=Λ(xᵢ, xⱼ)·Ω(yᵢ, yⱼ; xᵢ, xⱼ) to predict the sources or types of the potential malware, wherein Λ(xᵢ, xⱼ) is the similarity of the input information and Ω(yᵢ, yⱼ) is the similarity of the recognizable labeled information in the pattern database. Further, the embodiment of the invention utilizes a Gaussian kernel Λ to represent the distance or discrete degree of the input information, i.e. the operation as

$$Λ ( {x}_{i} , {x}_{j} ) = exp ( - \frac{{‖ φ ( {x}_{i} ) - φ ( {x}_{j} ) ‖}^{2}}{2 {σ}^{2}} ) ,$$

wherein the condition as φ:χ [symbol] [symbol] ⁿ is hold and n equals 4 to represent that there are four sources of the operation or data derived from the computing device, the remote storage device, the application program, or the network information. Additionally, the embodiment of the invention process the operation as Ω(yᵢ, yⱼ; xᵢ, xⱼ)=Σₗ^{L}βₗΩₗ(yᵢ, yⱼ; xᵢ, xⱼ) to represent the similarity of a specific recognizable labeled information, and there are three kernels operations of the malware to be introduced in the embodiment of the invention, such as the Node kernel operation representing the position, the Token kernel representing the signature and the Script kernel representing the script information.

Under such circumstances, when the recognition result of the kernel operation is obtained to detect that there is at least one of the body or the sub-bodies of the malware being carried in the input information, the machine learning module 104 of the embodiment can provide the prescriptive analytics result to the user equipment 12. The prescriptive analytics result of the embodiment comprises one or more than one selection (s) for the scanning virus operation to inform the user utilizing the user equipment 12 of several solutions/selections of the scanning virus operation, so as to delete or isolate the electronic file carrying the body or the sub-bodies of the malware (i.e. the potential pieces of the virus pattern information). Alternatively, the machine learning module 104 of the embodiment can provide the cognitive analytics result to inform the user utilizing the user equipment 12 that the user equipment 12 is currently attacked or invaded by a specific type of malware and the specific scanning virus operation corresponding to the specific type of malware is suggested to be applied to the user equipment 12 for preventing the malfunction or distortion of electronic files of the user equipment 12.

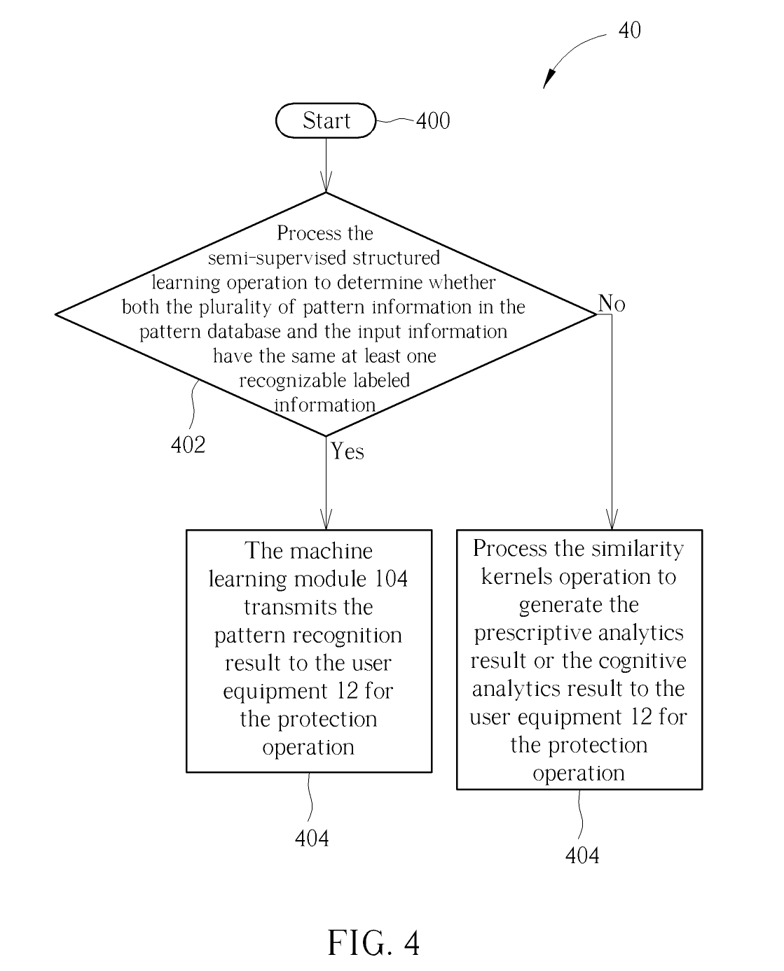

Further, the recognition operation in step 208 for the machine learning module 104 can be summarized as a recognition process 40 to be stored as the program code in the storage device 102. The recognition process 40, as shown in FIG. 4, of the invention comprises the following steps:

Step 400: Start.

Step 402: Process the semi-supervised structured learning operation to determine whether both the plurality of pattern information in the pattern database and the input information have the same at least one recognizable labeled information. If the same at least one recognizable labeled information exists, process step 404; otherwise, process step 406.

Step 404: The machine learning module 104 transmits the pattern recognition result to the user equipment 12 for the protection operation.

Step 406: Process the similarity kernels operation to generate the prescriptive analytics result or the cognitive analytics result to the user equipment 12 for the protection operation.

The detailed operations of the recognition operation 40 can be understood in related paragraphs for demonstrating step 208 and step 210, and are not described hereinafter for brevity.

In short, the user equipment 12 of the embodiment does not directly store or predetermine the pattern database. Instead, the user equipment 12 of the embodiment receives the pattern recognition result derived from the completed recognition operation of the machine learning module 104 of the computer system 10, so as to process the related scanning virus operations. In comparison with the prior art for storing large data information of the virus pattern database, the user equipment 12 of the embodiment has less hardware requirement in production. Besides, the embodiment of the invention utilizes the two stage of the training/learning operations via the transductive machine learning and inductive machine learning to dynamically update the pattern database. The prior art must utilize lots of labors and times to maintain/process the recognition operation and the updating operation for the potential pieces of the virus pattern information. In contrast, the embodiment of the invention has the advantages from the two-stage training/learning operation to efficiently improve the recognition for all types of the malware, so as to enhance the operational convenience and application range of the user equipment 12.

Noticeably, the embodiment of the invention is not limiting the communication way and timing thereof for the computer system 10 and the user equipment 12, such that the input information of the embodiment can be obtained from either the computer system 10 or the user equipment 12. Accordingly, after the operation of the machine learning module 104 of the computer system 10, the user equipment 12 of the embodiment correspondingly obtains the protection operation from the computer system 10 to assist the scanning virus operation of the user equipment 12 against the attack of the malware. Certainly, those skilled in the art can add other transmission coding operations or certification mechanisms to cooperate with the communication between the computer system 10 and the user equipment 12, which is not limiting the scope of the invention.

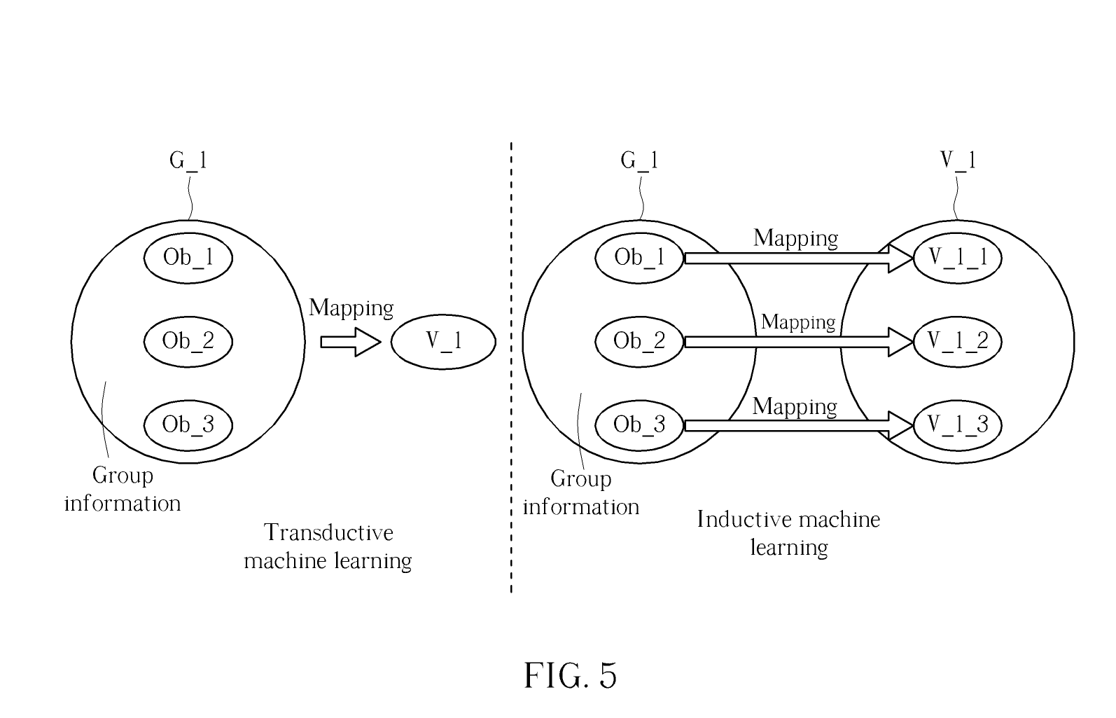

Moreover, please refer to FIG. 5, which illustrates a schematic diagram of a mapping result of the transductive machine learning and the inductive machine learning according to an embodiment of the invention. The left of FIG. 5 shows the mapping result of the transductive machine learning, wherein only the group information G_1 is shown to comprise three observed information Ob_1-Ob_3, and the group information G_1 corresponds to the virus V_1 as one type of the malware. Besides, the right of FIG. 5 shows the mapping result of the inductive machine learning, wherein the observed information Ob_1-Ob_3 are further classified into three specific virus classification V_1_1-V_1_3. In that, the embodiment of FIG. 5 shows how the transductive machine learning and the inductive machine learning are operated to correspondingly obtain the first mapping information and the second mapping information, and those skilled in the art can adaptively modify or combine other training/learning modules to form the two stage training/learning operation of the invention and to provide the accurate mapping result for timely updating the pattern database, which is also in the scope of the invention.

In summary, the embodiments of the invention provide a computer system comprising the machine learning module. By receiving the training information from the transductive machine learning and the inductive machine learning, the computer system of the embodiments can timely update the pattern database of the machine learning module. Also, the user equipment of the embodiments is not necessary to store the great amount of the data information of the virus pattern database. Instead, the user equipment receives the pattern recognition result obtained derived from the recognition operation of the machine learning module to avoid the disposition of extra-large storage spaces for the virus pattern database, which can efficiently reduce the production cost and broaden the application range of the user equipment.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A protection method to be utilized for a user equipment against an attack of a malware, the protection method comprising:
obtaining an observed information comprising at least one of a sampled information and a labeled information;
transforming the observed information to a first mapping information according to a transductive machine learning;
transforming the first mapping information to a second mapping information according to an inductive machine learning, and transmitting the second mapping information to a machine leaning module;
the machine leaning module receiving an input information, and utilizing a pattern database to generate a pattern recognition result; and
transmitting the pattern recognition result to the user equipment for a protection operation.

2. The protection method of claim 1, wherein the input information is obtained from an operation or a data corresponding to a computing device, a remote storage device, an application program, or a network information, and the observed information is one of the operation or the data of the input information.

3. The protection method of claim 1, wherein the transductive machine learning utilizes a recognizable labeled information to make the observed information map to a plurality of cluster information for forming the first mapping information, wherein each cluster information corresponds to a labeled cluster.

4. The protection method of claim 3, wherein the inductive machine learning receives the first mapping information and classifies each labeled cluster into a plurality of sub-labeled clusters, to make the mapped observed information of each of the cluster information map to the plurality of sub-labeled clusters, so as to obtain a mapping result, representing at least one of the sampled information and the labeled information of the plurality of cluster information mapping to the plurality of sub-labeled clusters, and form the second mapping information.

5. The protection method of claim 4, wherein the second mapping information is utilized for updating the pattern database of the machine leaning module, and the pattern database comprises a plurality of pattern information and each pattern information is a mapping result representing a labeled information mapping to a sub-labeled cluster.

6. The protection method of claim 5, wherein the machine leaning module processes a recognition operation between the plurality of pattern information and the input information to generate the pattern recognition result, so as to provide the user equipment with the protection operation.

7. The protection method of claim 6, further comprising processing a semi-supervised structured learning operation to determine whether both the plurality of pattern information and the input information have the same at least one recognizable labeled information, and if the at least one recognizable labeled information exists, the at least one recognizable labeled information and its corresponding scrip information forms the pattern recognition result to be transmitted to the user equipment for the protection operation, wherein the recognizable labeled information is a structure pattern of an electronic file.

8. The protection method of claim 7, wherein if the at least one recognizable labeled information does not exist between the plurality of pattern information and the input information, a similarity kernels operation is processed to generate a prescriptive analytics result or a cognitive analytics result as the pattern recognition result to be transmitted to the user equipment for the protection operation.

9. A computer system, coupled to a user equipment against an attack of a malware, the computer system comprising:
a processing unit; and
a storage device, coupled to the processing unit and storing a program code for processing a protection method, the protection method comprising:
obtaining an observed information comprising at least one of a sampled information and a labeled information;
transforming the observed information to a first mapping information according to a transductive machine learning;
transforming the first mapping information to a second mapping information according to an inductive machine learning, and transmitting the second mapping information to a machine leaning module;
the machine leaning module receiving an input information, and utilizing a pattern database to generate a pattern recognition result; and
transmitting the pattern recognition result to the user equipment for a protection operation.

10. The computer system of claim 9, wherein the input information is obtained from an operation or a data corresponding to a computing device, a remote storage device, an application program, or a network information, and the observed information is one of the operation or the data of the input information.

11. The computer system of claim 9, wherein the protection method further comprises the transductive machine learning utilizing a recognizable labeled information to make the observed information map to a plurality of cluster information for forming the first mapping information, and each cluster information corresponds to a labeled cluster.

12. The computer system of claim 11, wherein the protection method further comprises the inductive machine learning receiving the first mapping information and classifying each labeled cluster into a plurality of sub-labeled clusters, to make the mapped observed information of each of the cluster information map to the plurality of sub-labeled clusters, so as to obtain a mapping result, representing at least one of the sampled information and the labeled information of the plurality of cluster information mapping to the plurality of sub-labeled clusters, and form the second mapping information.

13. The computer system of claim 12, wherein the protection method further comprises utilizing the second mapping information for updating the pattern database of the machine leaning module, and the pattern database comprises a plurality of pattern information and each pattern information is a mapping result representing a labeled information mapping to a sub-labeled cluster.

14. The computer system of claim 13, wherein the protection method further comprises the machine leaning module processing a recognition operation between the plurality of pattern information and the input information to generate the pattern recognition result, so as to provide the user equipment with the protection operation.

15. The computer system of claim 14, wherein the protection method further comprises processing a semi-supervised structured learning operation to determine whether both the plurality of pattern information and the input information have the same at least one recognizable labeled information, and if the at least one recognizable labeled information exists, the at least one recognizable labeled information and its corresponding scrip information forms the pattern recognition result to be transmitted to the user equipment for the protection operation, wherein the recognizable labeled information is a structure pattern of an electronic file.

16. The computer system of claim 15, wherein the protection method further comprises if the at least one recognizable labeled information does not exist between the plurality of pattern information and the input information, processing a similarity kernels operation to generate a prescriptive analytics result or a cognitive analytics result as the pattern recognition result to be transmitted to the user equipment for the protection operation.
